(19) United States
(12) Patent Application Publication
(10) Pub. No.: US 2010/0077865 A1
(43) Pub. Date: Apr. 1, 2010

(54) FLOWMETER, IN PARTICULAR INDUCTIVE FLOWMETER

(75) Inventors: Karl-Heinz Rackebrandt, Adelebsen (DE); Klaus Schäfer, Hannoversch Munden (DE)

Correspondence Address: BUCHANAN, INGERSOLL & ROONEY PC, POST OFFICE BOX 1404, ALEXANDRIA, VA, 22313-1404, US

(73) Assignee: ABB Technology AG, Zürich (CH)

(21) Appl. No.: 12/564,410

(22) Filed: Sep. 22, 2009

(30) Foreign Application Priority Data
Sep. 22, 2008 (DE) 102008048317.6

(51) Int. Cl. G01F 1/58

(52) U.S. Cl. 73/861.12

(57) ABSTRACT

A flowmeter, such as an inductive flowmeter, is disclosed which includes a measuring tube made of plastic or haivng at least one plastic lining. Exemplary embodiments can assess a measurement in a highly accurate and reliable manner, and measure further physical variables using a relatively simple design, wherein measuring devices can be directly connected to a flow measurement location. For example, at least one pressure and/or temperature and/or field sensor can be introduced into plastic material of the plastic measuring tube or the plastic lining.

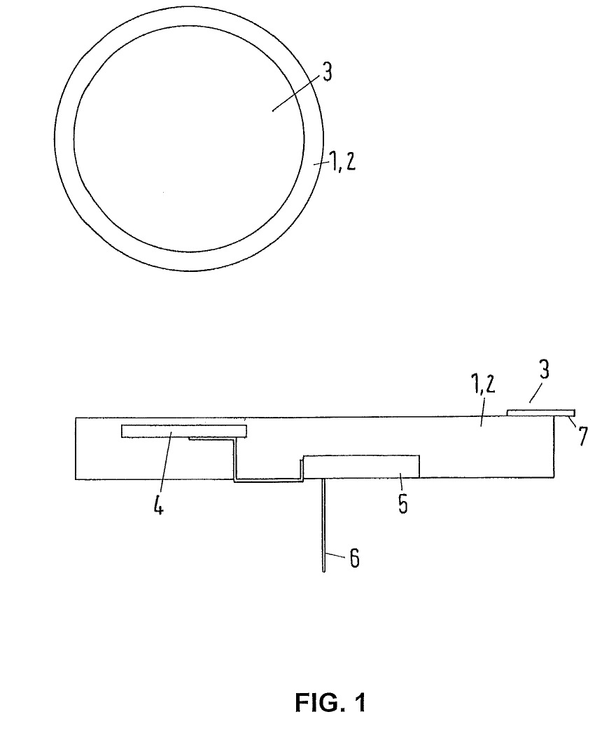

### RELATED APPLICATION

This application claims priority under 35 U.S.C. §119 to German Patent Application No. 10 2008 048 317.6 filed in Germany on Sep. 22, 2008, the entire content of which is hereby incorporated by reference in its entirety.

### FIELD

The disclosure relates to a flowmeter, such as an inductive flowmeter, having a measuring tube which is made of plastic or at least one plastic lining.

### BACKGROUND INFORMATION

Flowmeters are known which operate by magnetic induction with the aid of a magnetic system arranged on the outside of the measuring tube and electrodes which are arranged in the measuring tube and touch the substance being measured. However, capacitive flowmeters which operate with electrodes which do not touch the substance being measured are also known.

Examples of magnetically inductive flowmeters, such as capacitive flowmeters with a plastic measuring tube, are disclosed in EP 1 193 474 A1. In that case, the electrodes are embedded in a plastic measuring tube.

In addition, self-diagnosis measures of the measuring device can be carried out using the electrodes.

In addition, however, there are physical variables which cannot be determined by these devices but would be desired for accurate diagnosis of physical boundary conditions for the measurement. In order to determine the variables, separate devices for measuring other physical variables can be provided in the vicinity of the operating environment of the flowmeter.

### SUMMARY

A flowmeter is disclosed, comprising a measuring tube made of plastic or containing at least one plastic lining, and including electrodes arranged on the measuring tube at a location where they will touch a substance to be measured when in use; and at least one pressure and/or temperature and/or field sensor in plastic material used to form the plastic measuring tube or the plastic lining.

### BRIEF DESCRIPTION OF THE DRAWINGS

An exemplary embodiment disclosed herein is illustrated in the drawing, and is explained in more detail below in the detailed description.

The upper part of the Figure shows a cross section through a measuring tube of an exemplary flowmeter.

### DETAILED DESCRIPTION

The Figure shows an exemplary embodiment of a flowmeter of a generic type wherein to evaluate a measurement in a highly accurate and reliable manner, means for measuring further physical variables can be, on the one hand, of simple design and, on the other hand, directly connected to a flow measurement location.

According to exemplary embodiments, at least one pressure and/or temperature and/or field sensor can be introduced into material of a plastic measuring tube or a plastic lining of the measuring tube. The field sensors intended can be either sensors for qualitatively/quantitatively detecting electrical fields and/or those which can be used to qualitatively/quantitatively detect magnetic fields. The latter include Hall sensors, for example. As a result of the sensors being directly implemented in the plastic measuring tube, on the one hand, a realtively simplistic measuring arrangement can be achieved, and, on the other hand, an ability to directly allocate the sensor values obtained to the flow measurement location can be provided.

In another exemplary embodiment, a sensor or sensors is/are concomitantly cast in the plastic of the measuring tube. The sensors can thus be optimally close to the measurement location and this implementation can also be a further simplification of the final installation. No additional field and/or pressure and/or temperature sensors need to be fitted.

Another advantageous embodiment provides for preamplifier electronics to be concomitantly cast in the plastic of the measuring tube. This implementation can provide a compact construction of the flowmeter despite a considerably extended measurement range.

Another advantageous embodiment provides for additional capacitive electrodes to be concomitantly cast in the measuring tube. This can affect the construction of the capacitive flowmeter, and such additional capacitive electrodes can also be used in the magnetically inductive flowmeter to detect additional variables and evaluate them in a parallel manner.

As an alternative to an implementation of solid electrodes, it is also possible, in an exemplary embodiment, to implement the electrodes as electrically conductive areas in the surface of the plastic which touches the substance being measured. These can be introduced into the interior of the measuring tube in the form of thin films or vapor-deposited layers, for example, where they are contact-connected and the associated electrical connections are routed to the outside.

Furthermore, the signal lines can be concomitantly cast, at least in sections, in the form of cables in the plastic of the measuring tube.

In addition, the signal lines can also be concomitantly cast as films in the plastic of the measuring tube.

Another exemplary embodiment involves concomitantly casting the signal lines in the form of printed conductor tracks in the plastic of the measuring tube.

In an exemplary embodiment, the Figure shows a measuring tube 1, which can, for example, be made of plastic, and/or the measuring tube 1 if appropriate can be a metallic measuring tube having, for example, at least one inner plastic coating 2.

The lower part of the Figure shows a partial longitudinal section through an exemplary measuring tube 1. In this case, the substance being measured 3 and the inner surface of the measuring tube 1 are touching. An embodiment in which the measuring tube 1 is composed of plastic is illustrated in this case. According to the disclosure, the sensors 4, for example a temperature sensor, a magnetic field sensor, and/or capacitive sensors etc., can be concomitantly injected into the plastic. Furthermore, this exemplary refinement also shows the concomitant injection of preamplifier electronics 5 which correspond to the sensors and/or the electrodes 7. The signal line 6 can also be concomitantly injected over a short section there.

In addition to the embodiment illustrated, a region in which the sensors 4, the electronics 5, the signal line 6 and the electrodes are integrally arranged may also be a plastic lining of an otherwise metallic measuring tube, or tube of any material. In that case, the lining is configured thick enough to concomitantly accommodate the elements. These are then also concomitantly injected there.

In this case, this signal line 6 can be connected to an evaluation unit.

This construction is suitable not only for inductive flowmeters but also for capacitive flowmeters or other similar devices.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A flowmeter, comprising:
a measuring tube made of plastic or containing at least one plastic lining, and including electrodes arranged on the measuring tube at a location where they will touch a substance to be measured when in use; and
at least one pressure and/or temperature and/or field sensor in plastic material used to form the plastic measuring tube or the plastic lining.

2. The flowmeter as claimed in claim 1, wherein the at least one sensor is concomitantly cast in the plastic material of the measuring tube or the plastic lining.

3. The flowmeter as claimed in claim 1, comprising:
preamplifier electronics concomitantly cast in the plastic material of the measuring tube or the plastic lining.

4. The flowmeter as claimed in claim 1, comprising:
additional capacitive electrodes concomitantly cast in the plastic material.

5. The flowmeter as claimed in claim 1, comprising:
electrically conductive areas in a surface of the plastic material which is to touch a substance being measured, the electrically conductive areas constituting the electrodes.

6. The flowmeter as claimed in claim 1, comprising:
signal lines concomitantly cast, at least in sections, as cables in the plastic material of the measuring tube or the plastic lining.

7. The flowmeter as claimed in claim 1, comprising:
signal lines concomitantly cast as films in the plastic material of the measuring tube or the plastic lining.

8. The flowmeter as claimed in claim 1, comprising:
signal lines concomitantly cast as printed conductor tracks in the plastic material of the measuring tube or the plastic lining thereof.

9. The flowmeter as claimed in claim 1, comprising:
a magnetic system such that the flowmeter is configured as a magnetically inductive flowmeter.

10. The flowmeter as claimed in claim 2, comprising:
preamplifier electronics concomitantly cast in the plastic material of the measuring tube or the plastic lining.
